(19) United States
(12) Patent Application Publication
(10) Pub. No.: US 2026/0070795 A1
(43) Pub. Date: Mar. 12, 2026

(54) SPHERICAL SILICA POWDER AND METHOD FOR PRODUCING SPHERICAL SILICA POWDER

(71) Applicants: AGC Inc., Tokyo (JP); AGC SI-TECH CO., LTD., Kitakyushu-shi (JP)

(72) Inventors: Hiromichi KAMO, Tokyo (JP); Masaki INOUE, Fukuoka (JP); Ryuma ICHIKAWA, Tokyo (JP)

(73) Assignees: AGC Inc., Tokyo (JP); AGC SI-TECH CO., LTD., Kitakyushu-shi (JP)

(21) Appl. No.: 19/386,386

(22) Filed: Nov. 12, 2025

Related U.S. Application Data
(63) Continuation of application No. PCT/JP2024/016817, filed on May 1, 2024.

(30) Foreign Application Priority Data
May 15, 2023 (JP) 2023-080276

(51) Int. Cl. C01B 33/18; C08K 9/06

(52) U.S. Cl. CPC C01B 33/181; C08K 9/06; C01P 2002/82; C01P 2004/32; C01P 2004/61; C01P 2004/62; C01P 2006/12; C01P 2006/40

(57) ABSTRACT

A spherical silica powder, having a ratio (B/A) of 0.5 to 1.5, the ratio (B/A) being a ratio of a maximum IR peak intensity B, which is derived from an isolated silanol group on a surface of the spherical silica powder, at more than 3700 cm⁻¹ and 3800 cm⁻¹ or less to a maximum IR peak intensity A, which is derived from an internal silanol group of the spherical silica powder, at 3600 cm¹ to 3700 cm⁻¹.

### CROSS-REFERENCE TO RELATED APPLICATIONS

This is a continuation of International Application No. PCT/JP2024/016817 filed on May 1, 2024, and claims priority from Japanese Patent Applications No. 2023-080276 filed on May 15, 2023, the entire contents of which are incorporated herein by reference.

### TECHNICAL FIELD

The present invention relates to a spherical silica powder and a method for producing a spherical silica powder.

### BACKGROUND ART

In the related art, silica particles including silica (SiO₂) as a main component have been used for various applications, such as electronic materials for printed wiring boards, package wiring boards, and the like, optical materials for lenses, optical films, and the like, functional materials for catalysts, catalyst carriers, and the like, and pigments for paints, cosmetics, and the like.

In recent years, with an increase in an amount of information communication in a field of communications, utilization of high-frequency band signals has become widespread in electronic devices and communications equipment, and there is a demand for a material with a low dielectric loss tangent for use in high-frequency band devices. Silica has a small dielectric 25 constant (3.9), a small coefficient of thermal expansion (3 ppm/° C. to 7.9 ppm/° C.), is a promising filler material with a low dielectric constant and a low coefficient of thermal expansion, and is expected to be used in high-frequency band dielectric devices and the like.

Since a silanol (Si—OH) group contained in silica is a reason to cause an increase in dielectric loss, it is effective in improving dielectric characteristics to reduce the silanol group contained in silica. For example, it is discussed in Patent Literature 1 that an amount of silanol groups is reduced by firing silica having the silanol groups in a hydrogen gas flow at a temperature of 1100° C. or higher.
Patent Literature 1: JPH03-228817A

### SUMMARY OF INVENTION

However, when silanol groups are reduced to improve dielectric characteristics, there is a problem that compatibility between a spherical silica powder and a resin becomes poor, and adhesiveness to the resin is reduced. When the adhesiveness between the spherical silica and the resin is reduced, sufficient peeling strength may not be obtained if a resin composition obtained by mixing the spherical silica powder with the resin is used for an electronic application.

Therefore, an object of the present invention is to provide a spherical silica powder that exhibits low dielectric loss and excellent adhesiveness to a resin in a case of being mixed with the resin for an electronic application.

As a result of an extensive research, the inventors discovered that the above problems can be solved by setting a ratio of an amount of internal silanol groups of a spherical silica powder to an amount of isolated silanol groups on a surface of a spherical silica powder within a specific range, thereby completing the present invention.

The present invention relates to the following.

[1]A spherical silica powder, having a ratio (B/A) of 0.5 to 1.5, the ratio (B/A) being a ratio of a maximum IR peak intensity B, which is derived from an isolated silanol group on a surface of the spherical silica powder, at more than 3700 cm⁻¹ and 3800 cm⁻¹ or less to a maximum IR peak intensity A, which is derived from an internal silanol group of the spherical silica powder, at 3600 cm⁻¹ to 3700 cm¹.

[2] The spherical silica powder according to [1], in which the maximum IR peak intensity B, which is derived from the isolated silanol group on the surface of the spherical silica powder, at more than 3700 cm⁻¹ and 3800 cm⁻¹ or less is 0.1 or less.

[3] The spherical silica powder according to claim 1, having a sum (A+B) of less than 0.2, the sum (A+B) being a sum of the maximum IR peak intensity A, which is derived from the internal silanol group of the spherical silica powder, at 3600 cm⁻¹ to 3700 cm⁻¹ and the maximum IR peak intensity B, which is derived from the isolated silanol group on the surface of the spherical silica powder, at more than 3700 cm⁻¹ and 3800 cm⁻¹ or less.

[4] The spherical silica powder according to [1], in which a maximum IR peak intensity, which is derived from a silanol group of the spherical silica powder, at 3300 cm¹ to 3800 cm⁻¹ is 0.2 or less.

[5] The spherical silica powder according to [1], having a median diameter d50 of 0.5 μm to 20.0 μm.

[6] The spherical silica powder according to [1], having a specific surface area of 0.1 m²/g to 4.0 m²/g.

[7] The spherical silica powder according to [1], having a dielectric loss tangent of 0.0020 or less at a frequency of 1 GHz.

[8] The spherical silica powder according to [1], including: 30 ppm by mass to 1500 ppm by mass of Ti.

[9]A method for producing the spherical silica powder according to any one of [1] to [8], the method including firing a spherical silica precursor in a reducing atmosphere.

[10] The method for producing the spherical silica powder according to [9], further including: forming the spherical silica precursor by a wet method.

[11]A resin composition including: the spherical silica powder according to any one of [1] to [8]; and a resin.

According to the present invention, a spherical silica powder that exhibits low dielectric loss and excellent adhesiveness to a resin in a case of being mixed with the resin for an electronic application can be provided.

### DESCRIPTION OF EMBODIMENTS

The present invention will be described below, but the present invention is not limited to examples described below. In addition, in the present specification, an expression “to” used to express a numerical range includes numerical values before and after it as a lower limit value and an upper limit value of the range, respectively.

In the present specification, “mass” is synonymous with “weight”.

### <Spherical Silica Powder>

In a spherical silica powder of the present invention, a ratio (B/A) of a maximum IR peak intensity B, which is derived from an isolated silanol group on a surface of the spherical silica powder, at more than 3700 cm⁻¹ and 3800 cm⁻¹ or less to a maximum IR peak intensity A, which is derived from an internal silanol group of the spherical silica powder, at 3600 cm⁻¹ to 3700 cm⁻¹ is 0.5 to 1.5.

Generally, silanol groups (Si—OH) of silica particles are classified into an internal silanol group present within an Si—O network inside the particle, an isolated silanol group present on a particle surface and not bonded to water adsorbed to the silica particle, and a bonded silanol group bonded to water adsorbed to the silica particle or silanol on a silica surface. The silanol group, which is a polar functional group, is a reason to increase dielectric loss, and thus an amount of silanol groups is preferably reduced from a viewpoint of reducing the dielectric loss. However, the inventors have found that the fewer the isolated silanol groups present on the particle surface, the more inactive a surface of the spherical silica powder becomes, and thus compatibility at the time of mixing with the resin becomes poor and adhesiveness to the resin is reduced.

When the ratio (B/A) of the maximum IR peak intensity B, which is derived from the isolated silanol group on the surface of the spherical silica powder, at more than 3700 cm⁻¹ and 3800 cm⁻¹ or less to the maximum IR peak intensity A, which is derived from the internal silanol group of the spherical silica powder, at 3600 cm⁻¹ to 3700 cm⁻¹ is 0.5 to 1.5, the spherical silica powder that exhibits low dielectric loss and excellent adhesiveness to a resin in a case of being mixed with the resin for an electronic application can be provided.

In the spherical silica powder of the present invention, the maximum IR peak intensity A, which is derived from the internal silanol group, at 3600 cm⁻¹ to 3700 cm⁻¹ is preferably less than 0.2. When the number of internal silanol groups is large, in a case where a resin composition obtained by mixing the spherical silica powder with a resin is used for an electronic application, the dielectric loss tends to increase. However, when the maximum IR peak intensity A, which is derived from the internal silanol group of the spherical silica powder, at 3600 cm⁻¹ to 3700 cm⁻¹ is less than 0.2, the dielectric loss can be reduced. The maximum IR peak intensity A, which is derived from the internal silanol group, at 3600 cm⁻¹ to 3700 cm⁻¹ is more preferably 0.10 or less, further preferably 0.08 or less, and most preferably 0.05 or less. Since the internal silanol group does not interact with the resin and deteriorates the dielectric loss tangent, fewer internal silanol groups are preferred. Therefore, there is no particular lower limit.

In the spherical silica powder of the present invention, the maximum IR peak intensity B, which is derived from the isolated silanol group on the surface of the spherical silica powder, at more than 3700 cm⁻¹ and 3800 cm⁻¹ or less is preferably 0.1 or less. When the number of isolated silanol groups on the surface of the spherical silica powder is large, in the case where the resin composition obtained by mixing the spherical silica powder with the resin is used for the electronic application, the dielectric loss tends to increase. However, when the maximum IR peak intensity B, which is derived from the isolated silanol group on the surface of the spherical silica powder, at more than 3700 cm⁻¹ and 3800 cm⁻¹ or less is 0.1 or less, the dielectric loss can be reduced. The maximum JR peak intensity B, which is derived from the isolated silanol group on the surface of the spherical silica powder, at more than 3700 cm⁻¹ and 3800 cm⁻¹ or less is more preferably 0.05 or less, and further preferably 0.03 or less.

From a viewpoint of improving the adhesiveness to the resin when the spherical silica powder is mixed with the resin, the maximum IR peak intensity B, which is derived from the isolated silanol group on the surface of the spherical silica powder, at more than 3700 cm⁻¹ and 3800 cm⁻¹ or less is preferably 0.005 or more, more preferably 0.010 or more, further preferably 0.013 or more, and particularly preferably 0.015 or more.

That is, the maximum IR peak intensity B, which is derived from the isolated silanol group on the surface of the spherical silica powder, at more than 3700 cm⁻¹ and 3800 cm⁻¹ or less is preferably in a range of 0.005 to 0.1.

In the spherical silica powder of the present invention, the ratio (B/A) of the maximum IR peak intensity B, which is derived from the isolated silanol group on the surface, at more than 3700 cm⁻¹ and 3800 cm⁻¹ or less to the maximum IR peak intensity A, which is derived from the internal silanol group, at 3600 cm⁻¹ to 3700 cm⁻¹ is 0.5 to 1.5. When the B/A is 1.5 or less, the isolated silanol group that provides the adhesiveness at an interface between the resin and silica remains, while the amount of internal silanol groups that do not interact with the resin and deteriorate the dielectric loss tangent is sufficiently reduced, so that both the adhesiveness to the resin and reduction in the dielectric loss tangent can be achieved. When the B/A is 0.5 or more, the amount of internal silanol groups is reduced, and thus the dielectric loss tangent can be sufficiently reduced. Accordingly, when the spherical silica powder is mixed with the resin to form a resin composition on a substrate such as a metal, excellent peeling strength can be obtained.

The B/A is preferably 1.3 or less, more preferably 1.1 or less, and is preferably 0.6 or more, and more preferably 0.7 or more.

The ratio (B/A) of the maximum IR peak intensity B, which is derived from the isolated silanol group on the surface of the spherical silica powder, at more than 3700 cm⁻¹ and 3800 cm⁻¹ or less to the maximum IR peak intensity A, which is derived from the internal silanol group, at 3600 cm⁻¹ to 3700 cm⁻¹ can be adjusted by firing conditions during production of the spherical silica powder, a particle size of a silica precursor, and the like.

In the spherical silica powder of the present invention, a sum (A+B) of the maximum IR peak intensity A, which is derived from the internal silanol group, at 3600 cm⁻¹ to 3700 cm⁻¹ and the maximum TR peak intensity B, which is derived from the isolated silanol group on the surface of the spherical silica powder, at more than 3700 cm⁻¹ and 3800 cm⁻¹ or less is preferably less than 0.2. When the sum (A+B) of the maximum IR peak intensity A, which is derived from the internal silanol group, at 3600 cm⁻¹ to 3700 cm⁻¹ and the maximum IR peak intensity B, which is derived from the isolated silanol group on the surface of the spherical silica powder, at more than 3700 cm⁻¹ and 3800 cm⁻¹ or less is less than 0.2, the dielectric loss can be further reduced when the resin composition obtained by mixing the spherical silica powder with the resin is used for the electronic application. The A+B is more preferably 0.19 or less, further preferably 0.15 or less, particularly preferably 0.10 or less, and most preferably 0.05 or less.

From a viewpoint of improving the adhesiveness at the interface between the isolated silanol group on the silica surface and the resin, the A+B is preferably 0.02 or more, and more preferably 0.03 or more.

A maximum IR peak intensity, which is derived from the silanol group of the spherical silica powder, at 3300 cm⁻¹ to 3800 cm⁻¹ is preferably 0.2 or less, more preferably 0.1 or less, further preferably 0.05 or less, particularly preferably 0.02 or less, and most preferably 0.017 or less. When the maximum IR peak intensity at 3300 cm⁻¹ to 3800 cm⁻¹ is 0.2 or less, the dielectric loss can be reduced when the resin composition obtained by mixing the spherical silica powder with the resin is used in the electronic application.

From a viewpoint of improving the adhesiveness at the interface between the isolated silanol group on the silica surface and the resin, the maximum IR peak intensity, which is derived from the silanol group of the spherical silica powder, at 3300 cm⁻¹ to 3800 cm⁻¹ is preferably 0.010 or more.

An JR spectrum of the silanol group of the spherical silica powder can be measured by the following procedure.

### (Measurement Method)

An infrared spectrometer (for example, IR Prestige-21 (manufactured by Shimadzu Corporation)) is used and the IR spectrum of the silanol group of the spherical silica powder is measured by a diffuse reflection method with spherical silica powder dispersed in diamond. A measurement range is 400 cm⁻¹ to 4000 cm⁻¹, a resolution is 4 cm⁻¹, and a cumulative number is 128.

The dilution to the diamond powder is defined as [mass dilution ratio]=[(sample mass])/([diamond mass]+[sample mass]), and [mass dilution ratio]=85−2.5×[BET specific surface area].

The spherical silica powder vacuum-dried at 180° C. for 1 hour is used.

After normalizing the IR spectrum at 800 cm⁻¹ and aligning a baseline at 3800 cm⁻¹, a maximum IR peak at 3600 cm⁻¹ to 3700 cm⁻¹, a maximum IR peak at more than 3700 cm⁻¹ and 3800 cm⁻¹ or less, and a maximum IR peak at 3300 cm⁻¹ to 3800 cm⁻¹ are obtained.

In the spherical silica powder, a median diameter d50, which is a particle diameter at a point where a cumulative volume is 50% on a volume-based particle size distribution curve, is preferably 0.5 μm to 20.0 μm.

When the median diameter d50 of the spherical silica powder is 0.5 μm or more, the dielectric loss tangent can be significantly reduced. When the median diameter d50 of the spherical silica powder is 20.0 μm or less, a particle gauge value can be prevented from increasing, and thus excellent peeling strength can be obtained when the resin composition containing the spherical silica powder is used for the electronic application. Accordingly, in the present invention, the median diameter d50 of the spherical silica powder is preferably 0.5 μm to 20.0 μm, more preferably 0.5 μm to 10.0 μm, and further preferably 1 μm to 5.0 m.

A 10% particle diameter d10, which is a particle diameter at which the cumulative volume is 10% in the volume-based particle size distribution curve of the spherical silica powder, is preferably 0.5 μm to 5.0 μm, and more preferably 1.0 μm to 3.0 μm, from the viewpoint of improving uniform dispersibility when the spherical silica powder is mixed with the resin, and enhancing an interaction between the spherical silica powder and the resin.

A ratio (d50/d10) of the median diameter d50 to the 10% particle diameter d10 is preferably more than 1.0 and 5.0 or less, more preferably 1.3 to 4.0, and further preferably 1.5 to 3.0, from the viewpoint of improving the uniform dispersibility when the spherical silica powder is mixed with the resin, and enhancing the interaction between the spherical silica powder and the resin.

A maximum particle diameter (Dmax) of the spherical silica powder is preferably 150 times or less, more preferably 100 times or less, further preferably 50 times or less, and particularly preferably 10 times or less of the median diameter d50. When the maximum particle diameter (Dmax) is 150 times or less of the median diameter d50, it is difficult to cause defects when a sheet is processed. The maximum particle diameter (Dmax) is preferably 1.2 times or more, more preferably 1.5 times or more, and further preferably 2 times or more of the median diameter d50.

The median diameter d50 is a volume-based cumulative 50% diameter obtained by a laser diffraction particle size distribution analyzer (for example, “MT3300EXIT” manufactured by MicrotracBEL Corp.). That is, the particle size distribution is measured by the laser diffraction and scattering method, a cumulative curve is obtained by setting a total volume of the spherical silica powder to 100%, and the volume-based cumulative 50% diameter represents a particle diameter at a point on the cumulative curve where the cumulative volume is 50%.

The 10% particle diameter d10 is a volume-based cumulative 10% diameter obtained by the laser diffraction particle size distribution analyzer (for example, “MT3300EXII” manufactured by MicrotracBEL Corp.). That is, the particle size distribution is measured by the laser diffraction and scattering method, a cumulative curve is obtained by setting a total volume of the spherical silica powder to 100%, and the volume-based cumulative 10% diameter represents a particle diameter at a point on the cumulative curve where the cumulative volume is 10%.

The maximum particle diameter is also obtained by the same measurement as the median diameter d50 and the 10% particle diameter d10.

A specific surface area Y of the spherical silica powder of the present invention is preferably in a range of 0.1 m²/g to 4.0 m²/g. When the specific surface area Y is 0.1 m²/g or more, a contact point with the resin is sufficient when the spherical silica powder is contained in the resin composition, and thus, the powder becomes more compatible with the resin. When the specific surface area Y is 4.0 m²/g or less, the dielectric loss tangent can be reduced, and thus, an excellent low dielectric loss tangent even in the resin composition can be exhibited, and dispersibility in the resin composition can be improved. The specific surface area Y is preferably 4.0 m²/g or less, more preferably 3.5 m²/g or less, and particularly preferably 3.0 m²/g or less, and is preferably 0.1 m²/g or more, more preferably 0.2 m²/g or more, and particularly preferably 0.5 m²/g or more. It is substantially difficult to obtain particles with the specific surface area Y of less than 0.1 m²/g.

The specific surface area is obtained by a BET method based on a nitrogen adsorption method using the specific surface area and pore distribution measuring device (for example, “BELSORP-mini II” manufactured by MicrotracBEL Corp., “TriStar II” manufactured by Micromeritics Instrument Corporation).

A product Y×d50 of the specific surface area Y (m²/g) and the median diameter d50 (μm) of the spherical silica powder is preferably 2.7 μm·m²/g to 5.0 μm·m²/g. When the Y×d50 is 5.0 μm·m²/g or less, the specific surface area per particle diameter can be reduced, and the dielectric loss tangent can be reduced. The Y×d50 is preferably 2.7 μm·m²/g to 4.5 μm·m²/g, and more preferably 2.7 μm·m²/g to 4.0 μm·m²/g.

A theoretical value of the Y×d50 is 2.7 [derived from specific surface area=6/(true density of silica of 2.2 (g/cm³)×median diameter d50 (μm))], and values below this theoretical value are practically unachievable.

An average circularity of the spherical silica powder is preferably 0.75 to 1.0. When the average circularity is low, the specific surface area increases, and thus, the dielectric loss tangent easily increases, and therefore, the average circularity is preferably 0.75 or more. The average circularity is more preferably 0.85 or more, further preferably 0.90 or more, particularly preferably 0.93 or more, and is preferably close to 1.0.

The average circularity can be obtained by calculating an average value obtained by measuring a longest diameter (DL) and a short diameter (DS) orthogonal to the longest diameter (DL) of any 100 particles in a photograph projection view that is obtained by capturing with a scanning electron microscope (SEM), and calculating a ratio (DS/DL) of the shortest diameter (DS) to the longest diameter (DL).

The dielectric loss tangent of the spherical silica powder of the present invention is preferably 0.0020 or less, more preferably 0.0010 or less, and further preferably 0.0008 or less at the frequency of 1 GHz. Especially, in the measurement of the dielectric loss tangent and a dielectric constant of the powder, if the frequency is 10 GHz or more, a sample space becomes small and a measurement accuracy deteriorates, and thus, values measured at the frequency of 1 GHz are used in the present invention. When the dielectric loss tangent at the frequency of 1 GHz of the spherical silica powder is 0.0020 or less, an excellent reduction effect of dielectric loss can be obtained, and thus, a substrate or sheet having improved high-frequency characteristics can be obtained. As the dielectric loss tangent is smaller, a transmission loss of a circuit is reduced, and thus, a lower limit value thereof is not particularly limited.

From the same viewpoint, the dielectric constant of the spherical silica powder is preferably 5.0 or less, more preferably 4.5 or less, and further preferably 4.1 or less at the frequency of 1 GHz.

The dielectric loss tangent and the dielectric constant can be measured by a perturbation resonator method using a dedicated device (for example, “vector network analyzer E5063A” manufactured by a KEYCOM Corp.).

The spherical silica powder of the present invention preferably has a viscosity, which is measured by the following measuring method, of 5000 mPa s or less in a kneaded product containing the spherical silica powder.

### (Measurement Method)

A kneaded product obtained by mixing 8 parts by mass of the spherical silica powder and 6 parts by mass of boiled linseed oil specified by JIS K 5421:2000 and kneading the mixture at 2000 rpm for 3 minutes is measured for 30 seconds at a shear rate of 1 s¹ using a rotary rheometer, and a viscosity at 30 seconds is obtained.

When the viscosity at the shear rate of 1 s⁻¹ of the kneaded product obtained by the above measuring method is 5000 mPa·s or less, an amount of a solvent added during molding or film formation of a resin composition containing the spherical silica powder can be reduced, a drying rate can be increased, and productivity can be improved. When a specific surface area of a silica powder according to a particle diameter thereof increases, a viscosity tends to increase when the silica powder is added to a resin composition, and thus in order to prevent an increase in the viscosity of the resin composition, for example, the specific surface area of the spherical silica powder of the present invention is preferably reduced. The viscosity of the kneaded product is more preferably 4000 mPa·s or less, and further preferably 3500 mPa·s or less.

A lower limit value of the viscosity of the kneaded product at the shear rate of 1 s⁻¹ is not particularly limited because the lower the viscosity, the better a coating ability of the resin composition and the higher the productivity.

The spherical silica powder is preferably a non-porous particles. If the spherical silica powder is a porous particle, an oil absorption value increases, the viscosity in the resin increases, the surface area increases, the amount of silanol (Si—OH) groups on the surface of the silica particles increases, and the dielectric loss tangent tends to deteriorate. Specifically, the oil absorption value is preferably 100 ml/100 g or less, more preferably 70 ml/100 g or less, and most preferably 50 ml/100 g or less. A lower limit value thereof is not particularly limited, but it is substantially difficult to set the oil absorption value to 20 ml/100 g or less.

The spherical silica powder of the present invention preferably includes titanium (Ti) in a range of 30 ppm by mass to 1500 ppm by mass. A content of Ti is preferably 80 ppm by mass or more and more preferably 100 ppm by mass or more, and is preferably 1000 ppm by mass or less, and more preferably 500 ppm by mass or less. The content of Ti can be measured by inductively coupled plasma (ICP) emission spectrometry after adding perchloric acid and hydrofluoric acid to the silica powder, igniting the mixture, and removing silicon which is the main component.

Ti is a component that is optionally included in the production of the spherical silica powder. In the production of the spherical silica powder, if fine powder is generated due to crack of the silica particles, the fine powder adheres to a surface of a base particle, and the specific surface area of the particle is increased. By including Ti at the time of producing the spherical silica powder, it is easy to perform densification during firing. Accordingly, it is difficult to crack during post-processing after firing, and thus, generation of the fine powder can be prevented, and the number of adhesive particles adhering to the surface of the silica base particles can be reduced, thereby preventing an increase in the specific surface area. By including 30 ppm by mass or more of Ti, it is easy to perform densification during firing, and thus, the generation of the fine powder due to cracking can be reduced, and when the content of Ti is 1500 ppm by mass or less, the above-described effect can be obtained, an increase in the amount of the silanol group can be prevented and deterioration of the dielectric loss tangent can be prevented.

The spherical silica powder of the present invention may include an impurity element other than titanium (Ti) as long as the effect of the present invention is not impaired. Examples of the impurity element include Na, K, Mg, Ca, Al, and Fe in addition to Ti.

A content of an alkali metal and an alkaline earth metal in the impurity element is preferably 2000 ppm by mass or less, more preferably 1000 ppm by mass or less, and further preferably 200 ppm by mass or less in total.

### <Method for Producing Spherical Silica Powder>

A method for producing the spherical silica powder according to the present invention includes firing a spherical silica precursor in a reducing atmosphere.

### (Silica Precursor)

As the silica precursor, porous one is preferably used. The silica precursor is said to be porous if pores are uniformly distributed in the silica precursor.

By using the porous silica particle as the silica precursor, it is easier to obtain particles with controlled shape and particle size distribution, as compared with particles made by crushing and firing a non-porous raw material.

A pore volume of the silica precursor is preferably in a range of 0.1 ml/g to 2.0 ml/g. When the pore volume is 0.1 ml/g or more, an apparent volume of the particles decreases when the silica is made non-porous during firing to become particles having sparse particles, and thus a powder difficult to sinter, or weak in sintering strength is obtained. When the pore volume is 2.0 ml/g or less, a prepared bulk density before firing is prevented from becoming too large, thereby improving productivity, and the silica particles shrink sufficiently during firing, thereby allowing the specific surface area to be sufficiently small. The pore volume is more preferably 0.3 ml/g or more, further preferably 0.6 ml/g or more, and particularly preferably 0.7 ml/g or more, and is more preferably 1.8 ml/g or less, further preferably 1.5 ml/g or less, and particularly preferably 1.2 ml/g or less.

The specific surface area of the silica precursor is preferably in a range of 200 m²/g to 1000 m²/g. When the specific surface area is 200 m²/g or more, the surface area after firing can be reduced while preventing sintering of the particles. When the specific surface area is 1000 m²/g or less, strength of silica precursor particles is sufficiently high. The specific surface area is more preferably 400 m²/g or more, further preferably 500 m²/g or more, and particularly preferably 700 m²/g or more, and is more preferably 950 m²/g or less, and further preferably 900 m²/g or less.

The pore volume and the specific surface area are obtained by a BET method based on a nitrogen adsorption method using the specific surface area and pore distribution measuring device (for example, “BELSORP-mini II” manufactured by MicrotracBEL Corp., “TriStar II” manufactured by Micromeritics Instrument Corporation).

An average pore diameter of the silica precursor is preferably 1.0 nm to 50.0 nm. When the average pore diameter is 1.0 nm or more, the inside of the particles can be made uniformly non-porous, no air bubbles remain inside, and the dielectric loss tangent can be reduced. When the average pore diameter is 50.0 nm or less, the silica particles can be densified (made to have a lower specific surface area) by firing without any pores remained, and thus, the dielectric loss tangent can be lowered. The average pore diameter is more preferably 2.0 nm or more, further preferably 3.0 nm or more, and particularly preferably 4.0 nm or more, and more preferably 40.0 nm or less, further preferably 30.0 nm or less, and particularly preferably 20.0 nm or less.

The average pore diameter is obtained by the BET method based on the nitrogen adsorption method using the specific surface area and pore distribution measuring device (for example, “BELSORP-mini II” manufactured by MicrotracBEL Corp., “TriStar II” manufactured by Micromeritics Instrument Corporation).

It is preferable that the silica precursor used in the production method of the present invention is spherical and has an average circularity of 0.90 or more. When the average circularity is 0.90 or more, the particles are substantially spherical, so that the surface area of the particles can be reduced, and active surfaces are not exposed because protrusions are not chipped by vibration of the particles, so that the silica particles can have a low dielectric constant. The average circularity is more preferably 0.92 or more, particularly preferably 0.95 or more, and most preferably 1.00 since the closer to a perfect sphere the more desirable it is.

The average circularity can be calculated in the same manner as described above.

In the silica precursor, the median diameter d50, which is a particle diameter at a point where a cumulative volume is 50% on a volume-based particle size distribution curve, is preferably 1 μm to 500 μm. When the median diameter d50 of the silica precursor is 1 μm or more, the particles can be made spherical even after firing to reduce the surface area, and when d50 is 500 μm or less, it can be easily used as a filler for resin that is easily molded. The median diameter d50 is more preferably 1.2 μm or more, and further preferably 1.5 μm or more, and is more preferably 100 μm or less, further preferably 50 μm or less, particularly preferably 20 μm or less, especially preferably 10 μm or less, and most preferably 5 μm or less.

The silica precursor preferably has a weight loss ratio of 10% or less when dried at 230° C. for 12 hours. When the weight loss ratio is 10% or less, sintering of the particles hardly occurs when the silica precursor is fired in a state where the particles of the silica precursor are in contact with each other, and the spherical silica powder is easily obtained. The weight loss ratio is more preferably 9% or less, further preferably 8% or less, and particularly preferably 6% or less, and since it is desirable that the weight does not change even after drying at 230° C. for 12 hours, a lower limit thereof is not particularly limited.

When a water content of the obtained silica precursor is large and the weight loss ratio when the silica precursor is dried at 230° C. for 12 hours is more than 10%, the silica precursor is preferably dried so that the weight loss ratio becomes 10% or less. Examples of drying means include a spray dryer, static drying in a dryer, and ventilation treatment with dry air.

An ignition loss of the silica precursor is preferably 5.0 mass % to 15.0 mass %. The ignition loss is a sum of a mass of adhering water adhered to the silica precursor and a mass of water generated from condensation of the silanol group contained in the silica precursor, and the silica precursor has an appropriate silanol group, so that the condensation progresses during firing, and the silanol group easily decreases. When the ignition loss is too large, a yield during firing is lowered and productivity deteriorates, and therefore, the ignition loss of the silica precursor is preferably 15.0 mass % or less, more preferably 13.0 mass % or less, and most preferably 12.0 mass % or less. When the ignition loss is too small, the silanol group is likely to remain during firing, and therefore, the ignition loss of the silica precursor is preferably 5.0 mass % or more, more preferably 6.0 mass % or more, and most preferably 7.0 mass % or more.

Here, the ignition loss is determined in accordance with JIS K0067 (1992) as a mass loss when 1 g of the silica precursor is heated and dried at 850° C. for 0.5 hours.

The silica precursor may be obtained by production, or a commercially available product may be used. Examples of the commercially available product include H-11, H-31, and H-201 manufactured by AGC Si-Tech Co., Ltd.

When the silica precursor is obtained by production, the silica precursor can be obtained by a wet method, a granulation method, and the like. Among these, it is preferable to form the silica precursor by a wet method.

The wet method refers to a method including a step of obtaining a raw material of the spherical silica powder by using a liquid as a silica source and gelling the liquid. By using the wet method to form the silica precursor, spherical silica particles can be formed, and thus, there is no need to adjust a shape of the particles by crushing or the like, and as a result, particles with a small specific surface area can be obtained. In the wet method, the particles that are significantly smaller than an average particle diameter are hardly generated, and the specific surface area tends to be smaller after firing. In the wet method, an amount of the impurity element such as titanium can be adjusted by adjusting impurities of the silica source, and the above impurity element can be uniformly dispersed in the particles.

Examples of the wet method include a spraying method and an emulsion gelling method. In the emulsion gelling method, for example, a dispersed phase containing a silica precursor and a continuous phase are emulsified, and the obtained emulsion is gelled to obtain a spherical silica precursor. As an emulsification method, it is preferable to prepare an emulsion by supplying the dispersed phase containing the silica precursor to the continuous phase through fine pores or a porous film. Accordingly, an emulsion having a uniform liquid droplet diameter is prepared, and as a result, spherical silica having a uniform particle diameter is obtained. Such an emulsification method may be a micromixer method or a film emulsification method. For example, the micromixer method is disclosed in WO2013/062105A.

The spherical silica powder obtained as described above is amorphous solid silica.

The spherical silica powder of the present invention is obtained by firing the spherical silica precursor described above in the reducing atmosphere. It is presumed that firing the spherical silica precursor in the reducing atmosphere promotes the condensation of the silanol group and the reduction of an OH group. Accordingly, amounts of the isolated silanol groups on the surface of the spherical silica powder and the internal silanol groups of the spherical silica powder can be reduced, and in particular, the internal silanol groups are significantly reduced, and thus dielectric characteristics can be improved while the adhesiveness to the resin is maintained.

In the present specification, the “reducing atmosphere” refers to an atmosphere containing hydrogen. From the viewpoint of reaction equilibrium, a concentration of hydrogen is preferably 1 vol % or more, more preferably 3 vol % or more, further preferably 5 vol % or more, and particularly preferably 8 vol % or more. An upper limit of the concentration of hydrogen is 100 vol %.

The firing method is not particularly limited, and examples thereof include heat treatment with leaving to stand and heat treatment by a rotary furnace. For the heat treatment with leaving to stand, a stationary electric furnace, a roller hearth kiln, a continuous furnace classified as a tunnel furnace, or the like can be used. For the heat treatment by a rotary furnace, a horizontal rotary furnace (rotary kiln), a rotary tubular furnace, or the like can be used.

A firing temperature is preferably 700° C. or higher, more preferably 800° C. or higher, further preferably 900° C. or higher, and particularly preferably 1000° C. or higher. From the viewpoint of preventing the particles from being strongly sintered and reducing a particle gauge in a resin composition, the firing temperature is preferably 1600° C. or lower, more preferably 1500° C. or lower, and further preferably 1400° C. or lower.

A firing time may be appropriately adjusted in accordance with a firing device to be used and the firing temperature, and the heat treatment is preferably performed, for example, for 0.5 hours to 50 hours, and more preferably 1 hour to 10 hours.

Examples of a method for forming the reducing atmosphere include a method using reducing gases such as hydrogen gas and carbon monoxide. Examples of a device for forming the reducing atmosphere include an atmospheric furnace that can utilize the reducing gas, and the device may include a heater, a chamber filled with an inert gas (nitrogen, argon, and the like), a mechanism for drawing a vacuum inside the chamber, and the like in the furnace, so that the reducing gas can be more easily controlled.

The particles of the spherical silica powder may be weakly sintered together after firing, and thus, in that case, the spherical silica powder may be crushed. In order to maintain the surface area, crushing is preferably carried out such that an average circularity of the particles does not fall below 0.90 so as not to impair effects of the present invention. It is preferable that the surface area is not increased by the crushing treatment. A large increase in the surface area in the crushing treatment means that some of the spherical particles are crushed and fine damage occurs on the surface to generate fine powder. An increase in the surface area is not preferable because this increase leads to an increase in viscosity when the spherical silica powder is dispersed in the resin and leads to deterioration in the dielectric loss tangent.

The crushing can be performed using a crushing device such as a cyclone mill, a jet mill, or an impact mill, or can also be performed using an agate mortar or a vibrating sieve.

The spherical silica powder obtained by firing may be subjected to a surface treatment with a silane coupling agent. According to this step, the silanol group, which is present on the surface of the spherical silica powder, and the silane coupling agent react with each other, the silanol group on the surface is decreased, and the dielectric loss tangent is enhanced. Since the surface is hydrophobized and the affinity for the resin is improved, the dispersibility in the resin is improved.

Conditions for the surface treatment are not particularly limited, and general surface treatment conditions may be used, and a wet treatment method or a dry treatment method can be used. From the viewpoint of performing a uniform treatment, a wet treatment method is preferable.

Examples of the silane coupling agent used in the surface treatment include aminosilane coupling agents, epoxysilane coupling agents, mercaptosilane coupling agents, silane-based coupling agents, fluorine-containing silane coupling agents, and organosilazane compounds. These may be used alone or in combination of two or more kinds thereof.

Specifically, examples of the surface treatment agent (silane coupling agent) include an aminosilane coupling agent such as aminopropylmethoxysilane, aminopropyltriethoxysilane, ureidopropyltriethoxysilane, N-phenylaminopropyltrimethoxysilane, and N-2(aminoethyl)aminopropyltrimethoxysilane, an epoxysilane coupling agent such as glycidoxypropyltrimethoxysilane, glycidoxypropyltriethoxysilane, glycidoxypropylmethyldiethoxysilane, glycidylbutyltrimethoxysilane, and (3,4-epoxycyclohexyl)ethyltrimethoxysilane, a mercaptosilane coupling agent such as mercaptopropyltrimethoxysilane and mercaptopropyltriethoxysilane, a silane-based coupling agent such as methyltrimethoxysilane, vinyltrimethoxysilane, octadecyltrimethoxysilane, phenyltrimethoxysilane, methacroxypropyltrimethoxysilane, imidazolesilane, and triazinesilane, a fluorine-containing silane coupling agent such as CF₃(CF₂)₇CH₂CH₂Si(OCH₃)₃, CF₃(CF₂)₇CH₂CH₂SiCl₃, CF₃(CF₂)₇CH₂CH₂Si(CH₃)(OCH₃)₂, CF₃(CF₂)₇CH₂CH₂Si(CH₃)Cl₂, CF₃(CF₂)₅CH₂CH₂SiCl₃, CF₃(CF₂)₅CH₂CH₂Si(OCH₃)₃, CF₃CH₂CH₂SiCl₃, CF₃CH₂CH₂Si(OCH₃)₃, CsFi₇SO₂N(C₃H₇)CH₂CH₂CH₂Si(OCH₃)₃, C₇F₁₅CONHCH₂CH₂CH₂Si(OCH₃)₃, CsFi₇CO₂CH₂CH₂CH₂Si(OCH₃)₃, C₈F₁₇—O—CF(CF₃)CF₂—O—C₃H₆SiCl₃, and C₃F₇—O—(CF(CF₃)CF₂—O)₂—CF(CF₃)CONH—(CH₂)₃Si(OCH₃)₃, and an organosilazane compounds such as hexamethyldisilazane, hexaphenyldisilazane, trisilazane, cyclotrisilazane, and 1,1,3,3,5,5-hexamethylcyclotrisilazane.

A treatment amount of the silane coupling agent is preferably 0.01 parts by mass or more, more preferably 0.02 parts by mass or more, and further preferably 0.10 parts by mass or more, and is preferably 5 parts by mass or less, and more preferably 2 parts by mass or less with respect to 100 parts by mass of the spherical silica powder.

Examples of the method for treating with the silane coupling agent include a dry method in which the silane coupling agent is sprayed to the spherical silica powder, and a wet method in which the spherical silica powder is dispersed in a solvent and then a silane coupling agent is added to react with the mixture.

Note that it can be confirmed by detection of a peak of a substituent group of the silane coupling agent using IR that the surface of the spherical silica powder is treated with a silane coupling agent. An adhesion amount of the silane coupling agent can be measured by an amount of carbon.

### <Resin Composition>

The spherical silica powder of the present invention has excellent adhesiveness to the resin, and thus mixability with the resin composition is excellent.

The resin composition according to the present embodiment includes the spherical silica powder of the present invention and a resin. A content of the spherical silica powder in the resin composition is preferably 5 mass % to 90 mass %, more preferably 10 mass % to 85 mass %, further preferably 10 mass % to 80 mass %, particularly preferably 10 mass % to 75 mass %, still particularly preferably 10 mass % to 70 mass %, and most preferably 15 mass % to 70 mass %. When the content of the spherical silica powder is 5 mass % or more, sufficient peeling strength can be obtained, and when the content thereof is 90 mass % or less, the viscosity of the resin composition does not increase too much and can be treated easily. Here, a content of the spherical silica powder in the resin composition is preferably 5 mass % or more, more preferably 10 mass % or more, further preferably 15 mass % or more, and is preferably 90 mass % or less, more preferably 85 mass % or less, further preferably 80 mass % or less, particularly preferably 75 mass % or less, and most preferably 70 mass % or less.

The resin may use one or two or more types of a polyamide resin such as an epoxy resin, a silicone resin, a phenol resin, a melamine resin, a urea resin, an unsaturated polyester resin, a fluororesin, a polyimide resin, a polyamide-imide resin, or a polyether imide; a polyester resin such as a polybutylene terephthalate and a polyethylene terephthalate; a polyphenylene ether resin, a polyphenylene sulfide resin, an ortho-divinyl benzene resin, an aromatic polyester resin, a polysulfone, a liquid crystal polymer, a polyethersulfone, a polycarbonate, a maleic imide modified resin, an acrylonitrile butadiene styrene (ABS) resin, an acrylonitrile-acrylic rubber-styrene (AAS) resin, an acrylonitrile-ethylene-propylene-diene rubber-styrene (AES) resin, a poly tetrafluoroethylene (PTFE), a tetrafluoroethylene-perfluoroalkyl vinyl ether copolymer (PFA), a tetrafluoroethylene-hexafluoropropylene copolymer (FEP), and a tetrafluoroethylene-ethylene copolymer (ETFE). Since the dielectric loss tangent in the resin composition also depends on characteristics of the resin, the resin to be used may be selected in consideration of this factor.

The resin preferably includes a thermosetting resin. The thermosetting resins may be used alone or in combination. Examples of the thermosetting resin include an epoxy resin, a polyphenylene ether resin, a polyimide resin, a phenol resin, and an ortho-divinyl benzene resin. From the viewpoints of adhesiveness, heat resistance, and the like, the thermosetting resin is preferably an epoxy resin, a polyphenylene ether resin, or an ortho-divinyl benzene resin.

From the viewpoints of adhesiveness, dielectric characteristics, and the like, a weight average molecular weight of the thermosetting resin is preferably 1000 to 7000, more preferably 1000 to 5000, and further preferably 1000 to 3000. The weight average molecular weight is determined by gel permeation chromatography (GPC) in terms of polystyrene.

From the viewpoints of prevention on uneven distribution of the silica particles, reduction in water absorption, low dielectric loss tangent, adhesiveness, and the like, the content of the spherical silica powder with respect to 100 parts by mass of the thermosetting resin is preferably 10 parts by mass to 400 parts by mass, more preferably 50 parts by mass to 300 parts by mass, and further preferably 70 parts by mass to 250 parts by mass. In particular, when the silica particles are preferably highly filled, the content of the silica particles is preferably 80 parts by mass or more, and more preferably 90 parts by mass or more.

A particle size distribution of silica particles contained in the resin composition is preferably unimodal. The matter that the particle size distribution of the silica particles is unimodal can be confirmed from a matter that there is one peak in the particle size distribution according to a laser diffraction and scattering method.

The resin composition may contain an optional component other than the above resin and medium (for example, toluene and methyl ethyl ketone). Examples of the optional component include a dispersion aid, a surfactant, and a filler other than silica.

When a resin film is produced using the resin composition including the spherical silica powder of the present invention, the dielectric loss tangent is preferably 0.012 or less, more preferably 0.010 or less, and further preferably 0.009 or less at a frequency of 10 GHz. When the dielectric loss tangent at the frequency of 10 GHz of the resin film is 0.012 or less, the resin film can be expected to be used for electronic devices, communication devices, and the like because of excellent electrical characteristics. As the dielectric loss tangent is smaller, a transmission loss of a circuit is reduced, and thus, a lower limit value thereof is not particularly limited.

When the resin film is produced using the resin composition including the spherical silica powder of the present invention, a specific dielectric constant thereof is preferably 2.0 to 3.5 at the frequency of 10 GHz, a lower limit is more preferably 2.2 or more, further preferably 2.3 or more, and an upper limit is more preferably 3.2 or less, and further preferably 3.0 or less. When the relative permittivity of the resin film at the frequency of 10 GHz is within the above range, the resin film can be expected to be used for electronic devices, communication devices, and the like because of excellent electrical characteristics.

The specific dielectric constant can be measured by a perturbation resonator method using a dedicated device (for example, “vector network analyzer E5063A” manufactured by a KEYCOM Corp.).

The dielectric loss tangent of the resin film can be measured using a split post dielectric resonator (SPDR) (for example, manufactured by Agilent Technologies Japan, Ltd.).

The resin film preferably has an average coefficient of linear expansion of 10 ppm/° C. to 50 ppm/° C. When the average coefficient of linear expansion is in the above range, the range is close to a coefficient of thermal expansion of a copper foil widely used as a base material, and thus, the electrical characteristics are excellent. The average coefficient of linear expansion is more preferably 12 ppm/° C. or more, further preferably 15 ppm/° C. or more, and more preferably 40 ppm/° C. or less, and further preferably 30 ppm/° C. or less.

The average coefficient of linear expansion is determined by heating the resin film at a load of 5 N and a temperature increase rate of 2° C./min, measuring a dimensional change of a sample from 30° C. to 150° C., and calculating an average with using a thermomechanical analyzer (for example, “TMA-60” manufactured by SHIMADZU CORPORATION).

The spherical silica powder of the present invention can be used as various fillers, and can be particularly and suitably used as a filler in resin compositions used for production of an electronic substrate used in an electronic device such as a personal computer, a laptop, and a digital camera, and a communication device such as a smartphone and a game console. Specifically, the silica powder of the present invention is expected to be applied to a resin composition, a prepreg, a metal foil-clad laminate, a printed wiring board, a resin sheet, an adhesive layer, an adhesive film, a solder resist, a bump reflow, a rewiring insulating layer, a die bond material, a sealing material, an underfill, a mold underfill, a laminated inductor, and the like because the silica powder of the present invention has low dielectric loss tangent, the low transmission loss, the low moisture absorption, and the improved peeling strength.

As described above, the following configurations are disclosed in the present specification.

<1> A spherical silica powder, having a ratio (B/A) of 0.5 to 1.5, the ratio (B/A) being a ratio of a maximum IR peak intensity B, which is derived from an isolated silanol group on a surface of the spherical silica powder, at more than 3700 cm⁻¹ and 3800 cm⁻¹ or less to a maximum IR peak intensity A, which is derived from an internal silanol group of the spherical silica powder, at 3600 cm⁻¹ to 3700 cm¹.

<2> The spherical silica powder according to <1>, in which the maximum 1R peak intensity B, which is derived from the isolated silanol group on the surface of the spherical silica powder, at more than 3700 cm⁻¹ and 3800 cm⁻¹ or less is 0.1 or less.

<3> The spherical silica powder according to <1> or <2>, having a sum (A+B) of less than 0.2, the sum (A+B) being a sum of the maximum IR peak intensity A, which is derived from the internal silanol group of the spherical silica powder, at 3600 cm⁻¹ to 3700 cm⁻¹ and the maximum IR peak intensity B, which is derived from the isolated silanol group on the surface of the spherical silica powder, at more than 3700 cm⁻¹ and 3800 cm⁻¹ or less.

<4> The spherical silica powder according to any one of <1> to <3>, in which a maximum JR peak intensity, which is derived from a silanol group of the spherical silica powder, at 3300 cm⁻¹ to 3800 cm⁻¹ is 0.2 or less.

<5> The spherical silica powder according to any one of <1> to <4>, having a median diameter d50 of 0.5 μm to 20.0 m.

<6> The spherical silica powder according to any one of <1> to <5>, having a specific surface area of 0.1 m²/g to 4.0 m²/g.

<7> The spherical silica powder according to any one of <1> to <6>, having a dielectric loss tangent of 0.0020 or less at a frequency of 1 GHz.

<8> The spherical silica powder according to any one of <1> to <7>, including: 30 ppm by mass to 1500 ppm by mass of Ti.

<9> A method for producing the spherical silica powder according to any one of <1> to <8>, the method including firing a spherical silica precursor in a reducing atmosphere.

<10> The method for producing the spherical silica powder according to <9>, further including: forming the spherical silica precursor by a wet method.

<11> A resin composition including: the spherical silica powder according to any one of <1> to <8>; and a resin.

### EXAMPLES

Hereinafter, the present invention will be described with reference to Examples, but the present invention is not limited thereto. In the following description, common components employ the same substance.

Examples 1 to 2 are Comparative Examples, and Examples 3 to 7 are Inventive Examples.

### Example 1

A silica powder (SO—C₂ produced by ADMATECHS COMPANY LIMITED) was prepared as a silica precursor. The silica precursor (15 g) was washed with 150 ml of distilled water and dried at 200° C. for 12 hours, followed by being placed on an alumina crucible, and being subjected to a heat treatment (firing) at 1200° C. in air for 1 hour. After the heat treatment (firing), the mixture was cooled to 25° C. and crushed in an agate mortar to obtain a silica powder of Example 1.

### Example 2

Except that silica powder (H-31, d50=3.5 μm, produced by AGC Si-Tech Co., Ltd.) produced by a wet method was used as the silica precursor, a silica powder of Example 2 was obtained by the same operation as in Example 1.

### Example 3

Except that the silica precursor was fired in a hydrogen atmosphere, a silica powder of Example 3 was obtained by the same operation as in Example 2.

### Example 4

Except that a firing time of the silica precursor was changed to 3 hours, a silica powder of Example 4 was obtained by the same operation as in Example 3.

### Example 5

Except that the silica precursor was fired in a nitrogen atmosphere containing hydrogen, a silica powder of Example 5 was obtained by the same operation as in Example 2. A volume ratio of hydrogen and nitrogen was 1:9.

### Example 6

Except that a silica powder (H-11, d50=2.0 μm, produced by AGC Si-Tech Co., Ltd.) produced by a wet method was prepared as the spherical silica precursor and the silica precursor was fired in a nitrogen atmosphere containing hydrogen, a silica powder of Example 6 was obtained by the same operation as in Example 2. The volume ratio of hydrogen and nitrogen was 1:9.

### Example 7

Except that a silica powder (H-201, d50=20.0 μm, produced by AGC Si-Tech Co., Ltd.) produced by a wet method was prepared as the spherical silica precursor and the silica precursor was fired in a nitrogen atmosphere containing hydrogen, a silica powder of Example 7 was obtained by the same operation as in Example 2. The volume ratio of hydrogen and nitrogen was 1:9.

The silica powders of Examples 1 to 7 were evaluated as follows. The results are shown in Table 1.

### <Silanol Group>

An amount of silanol groups on a surface of the spherical silica powder was measured by an infrared spectroscopy spectrum.

The infrared spectroscopy spectrum was measured by a diffuse reflection method using IR Prestige-21 (manufactured by Shimadzu Corporation) with spherical silica powder dispersed in diamond. A measurement range was 400 cm⁻¹ to 4000 cm⁻¹, a resolution was 4 cm⁻¹, and a cumulative number was 128.

The dilution to the diamond powder was defined as [mass dilution ratio]=[(sample mass])/([diamond mass]+[sample mass]), and [mass dilution ratio]=85−2.5×[BET specific surface area].

The spherical silica powder vacuum-dried at 180° C. for 1 hour was used.

After normalizing the IR spectrum at 800 cm⁻¹ and aligning a baseline at 3800 cm⁻¹, a maximum IR peak intensity A at 3600 cm⁻¹ to 3700 cm⁻¹, a maximum IR peak intensity B at more than 3700 cm⁻¹ and 3800 cm⁻¹ or less, and a maximum IR peak intensity at 3300 cm⁻¹ to 3800 cm⁻¹ were obtained.

### <Median Diameter>

The median diameter was measured by a laser diffraction particle size distribution analyzer (MT3300EXII manufactured by MicrotracBEL Corp.). The measurement was performed after the spherical silica powder was dispersed by irradiating ultrasonic waves three times each for 60 seconds in the device. The measurement was performed twice each for 60 seconds, and an average value was obtained.

### <Specific Surface Area>

The spherical silica powder was dried under reduced pressure at 230° C. to completely remove water, thereby obtaining a sample. Regarding this sample, the specific surface area was obtained by a multi-point BET method using a nitrogen gas in “TriStar II”, which is an automatic specific surface area and pore distribution measuring device manufactured by Micromeritics Instrument Corporation.

### <Dielectric Loss Tangent>

In a 30 ml PE poly bottle, 5 g of spherical silica powder, 20 ml of toluene, and 0.5 g of hexamethyldisilazane were placed and stirred, and then the powder was collected by filtration. The obtained powder was dried in a vacuum at 120° C. for 1 hour to obtain a surface-treated silica powder. The obtained surface-treated silica powder was subjected to measurement by a perturbation resonator method using a dedicated device (vector network analyzer E5063A, manufactured by KEYCOM Corp.) at a test frequency of 1 GHz, a test temperature of approximately 24° C., a humidity of approximately 45%, and for three times. Specifically, after the spherical silica powder was dried under a vacuum at 150° C., a cylinder made of polytetrafluoroethylene (PTFE) was filled with powder while sufficiently tapping, the dielectric constant was measured for each container, and then the dielectric constant was converted to the dielectric loss tangent using a filling rate of the powder in the container.

### <Content of Ti>

Perchloric acid and hydrofluoric acid were added to the spherical silica powder, and the obtained mixture was ignited to remove silicon as a main component, and a content of Ti was measured with ICP-AES (inductively coupled plasma-atomic emission spectroscopy) using ICPE-9000 (manufactured by SHIMADZU CORPORATION).

### <Average Circularity>

The average circularity was an average value obtained by measuring a longest diameter (DL) and a short diameter (DS) orthogonal to the longest diameter (DL) of any 100 particles in a photograph projection view that was obtained by capturing with a scanning electron microscope (SEM), and calculating a ratio (DS/DL) of the shortest diameter (DS) to the longest diameter (DL).

<Peel Strength>

In a poly bottle, 55 parts by mass of spherical silica powder obtained above, 59 parts by mass of polyphenylene ether resin, 16 parts by mass of butadiene-styrene random copolymer (Ricon 100, produced by Cray Valley), 25 parts by mass of triallyl isocyanurate (curing accelerator, produced by Mitsubishi Chemical Corporation, TAIC), 1 part by mass of α,α′-di(t-butylperoxy)diisopropylbenzene (curing agent, produced by NOF Corporation, Perbutyl P), and 80 parts by mass of toluene were placed, and an alumina ball having a diameter of 20 mm was placed and mixed at 30 rpm for 12 hours, and the alumina ball was then removed to obtain a liquid composition.

The liquid composition was impregnated and coated onto glass cloth of IPC Spec 2116, and then heated and dried at 160° C. for 4 minutes to obtain a prepreg. Copper foil (thickness: 18 μm, maximum height roughness Rz: 2 μm, MT18E, produced by MITSUI MINING & SMELTING CO., LTD.) was laminated on both sides of the prepreg, and the obtained laminate was heat-molded at 230° C. and a pressure of 30 kg/cm² for 120 minutes to obtain a resin-coated metal substrate.

Peel strength (peeling strength) between the prepreg and the carrier-attached copper foil was measured for this resin-coated metal substrate in accordance with IPC-TM650-2.4.8.

TABLE 1

| | | | | Silanol group | | | | |
|---|---|---|---|---|---|---|---|---|
| | | | | | Maximum IR | | | |
| | | | | | peak intensity B | | | |
| | | | | Maximum IR | at more than | | | Maximum IR |
| | Firing conditions | | | peak intensity | 3700 cm⁻¹ and | | | peak intensity |
| | Firing | Temperature | Time | A at 3600 cm⁻¹ | 3800 cm⁻¹ or | | | at 3300 cm⁻¹ |
| | atmosphere | [° C.] | [h] | to 3700 cm⁻¹ | less | A + B | B/A | to 3800 cm⁻¹ |
| Example 1 | Air | 1200 | 1 | 0.050 | 0.15 | 0.2 | 3.0 | 0.40 |
| Example 2 | Air | 1200 | 1 | 0.030 | 0.075 | 0.105 | 2.5 | 0.075 |
| Example 3 | Hydrogen | 1200 | 1 | 0.017 | 0.017 | 0.034 | 1.0 | 0.017 |
| Example 4 | Hydrogen | 1200 | 3 | 0.012 | 0.012 | 0.024 | 1.0 | 0.017 |
| Example 5 | Hydrogen | 1200 | 1 | 0.018 | 0.018 | 0.036 | 1.0 | 0.017 |
| | 1/nitrogen 9 | | | | | | | |
| Example 6 | Hydrogen | 1200 | 1 | 0.017 | 0.023 | 0.04 | 1.4 | 0.023 |
| | 1/nitrogen 9 | | | | | | | |
| Example 7 | Hydrogen | 1200 | 1 | 0.025 | 0.015 | 0.04 | 0.6 | 0.025 |
| | 1/nitrogen 9 | | | | | | | |

TABLE 1

| | Physical property | | | | | Evalua- |
|---|---|---|---|---|---|---|
| | | Specific | Dielectric | Content | Average | tion |
| | Median | surface | loss | of Ti | circu- | Peel |
| | diameter | area | tangent | [ppm by | larity | strength |
| | [μm] | [m²/g] | [—] | mass] | [—] | [N/cm] |
| Example 1 | 0.6 | 5.0 | 0.002 | 25 | 0.81 | 2.4 |
| Example 2 | 3.0 | 1.4 | 0.0008 | 130 | 0.92 | 4.2 |
| Example 3 | 3.0 | 1.4 | 0.0004 | 130 | 0.92 | 6.0 |
| Example 4 | 3.1 | 1.4 | 0.0003 | 130 | 0.92 | 5.4 |
| Example 5 | 3.0 | 1.4 | 0.0005 | 130 | 0.92 | 6.6 |
| Example 6 | 1.5 | 3.2 | 0.0006 | 230 | 0.88 | 4.8 |
| Example 7 | 18.0 | 0.2 | 0.0003 | 95 | 0.95 | 7.2 |

The spherical silica powders of Examples 3 to 7, which were Inventive Examples, all had lower dielectric loss tangents than those of Comparative Examples 1 and 2. In addition, peel strength was high, and thus the adhesiveness to the resin was excellent.

On the other hand, in the spherical silica powders of Examples 1 and 2, which were Comparative Examples, the ratio (B/A) of the maximum IR peak intensity B, which was derived from the isolated silanol group on the surface of spherical silica powder, at more than 3700 cm⁻¹ and 3800 cm⁻¹ or less to the maximum IR peak intensity A, which was derived from the internal silanol group, at 3600 cm⁻¹ to 3700 cm⁻¹ was more than 1.5, and as compared with Inventive Examples, the dielectric loss tangent was high and the peel strength was low, and thus the adhesiveness to the resin was low.

Although the present invention has been described in detail with reference to specific aspects, it is apparent to those skilled in the art that various changes and modifications can be made without departing from the spirit and scope of the present invention.

Note that the present application is based on a Japanese patent application (Japanese Patent Application No. 2023-080276) filed on May 15, 2023, the entire contents of which are incorporated herein by reference.

1. A spherical silica powder, having a ratio (B/A) of 0.5 to 1.5, the ratio (B/A) being a ratio of a maximum IR peak intensity B, which is derived from an isolated silanol group on a surface of the spherical silica powder, at more than 3700 cm⁻¹ and 3800 cm⁻¹ or less to a maximum IR peak intensity A, which is derived from an internal silanol group of the spherical silica powder, at 3600 cm⁻¹ to 3700 cm⁻¹.

2. The spherical silica powder according to claim 1, wherein
the maximum IR peak intensity B, which is derived from the isolated silanol group on the surface of the spherical silica powder, at more than 3700 cm⁻¹ and 3800 cm⁻¹ or less is 0.1 or less.

3. The spherical silica powder according to claim 1, having a sum (A+B) of less than 0.2, the sum (A+B) being a sum of the maximum IR peak intensity A, which is derived from the internal silanol group of the spherical silica powder, at 3600 cm⁻¹ to 3700 cm⁻¹ and the maximum IR peak intensity B, which is derived from the isolated silanol group on the surface of the spherical silica powder, at more than 3700 cm⁻¹ and 3800 cm⁻¹ or less.

4. The spherical silica powder according to claim 1, wherein
a maximum IR peak intensity, which is derived from a silanol group of the spherical silica powder, at 3300 cm⁻¹ to 3800 cm⁻¹ is 0.2 or less.

5. The spherical silica powder according to claim 1, having a median diameter d50 of 0.5 μm to 20.0 μm.

6. The spherical silica powder according to claim 1, having a specific surface area of 0.1 m²/g to 4.0 m²/g.

7. The spherical silica powder according to claim 1, having a dielectric loss tangent of 0.0020 or less at a frequency of 1 GHz.

8. The spherical silica powder according to claim 1, comprising:
30 ppm by mass to 1500 ppm by mass of Ti.

9. A method for producing the spherical silica powder according to claim 1, the method comprising:
firing a spherical silica precursor in a reducing atmosphere.

10. The method for producing the spherical silica powder according to claim 9, further comprising:
forming the spherical silica precursor by a wet method.

11. A resin composition comprising:
the spherical silica powder according to claim 1; and
a resin.
